(19) United States
(12) Patent Application Publication
(10) Pub. No.: US 2026/0307027 A1
(43) Pub. Date: Oct. 8, 2026

(54) SOURDOUGH STARTER APPLIANCE

(71) Applicant: Haier US Appliance Solutions, Inc., Wilmington, DE (US)

(72) Inventors: George Kensei Carpenter, Louisville, KY (US); Joshua Lee Price, Elizabethtown, KY (US)

(21) Appl. No.: 19/098,190

(22) Filed: Apr. 2, 2025

(51) Int. Cl. B01F 35/22; A21C 14/00; B01F 35/32; B01F 101/08; G06F 9/451

(52) U.S. Cl. CPC B01F 35/2203; A21C 14/00; B01F 35/3204; B01F 2101/08; G06F 9/451

(57) ABSTRACT

A method of sourdough starter planning includes receiving a feeding instruction of a growing operation and calculating, via a planning algorithm, operating parameters based upon the feeding instruction. The operating parameters include one or more of a quantity of starter seed, a dosing schedule, and a dosing quantity. The method also includes providing a user instruction based upon the calculated operating parameters from the planning algorithm.

### FIELD OF THE INVENTION

The present subject matter relates generally to sourdough starter appliances, and to methods of operating such appliances.

### BACKGROUND OF THE INVENTION

Sourdough bread baking is a traditional, time-tested practice with a passionate community of bakers. Before the invention of commercial yeast, bread bakers achieved leavening by introducing live bacteria & yeast cultures that produced fermented gases. The culture, known as a sourdough starter, is developed, cultivated, and maintained through a meticulous process independent from the actual bread baking. A typical sourdough starter process includes a user feeding and growing a sourdough starter. Such processes may produce varying amounts of sourdough starter each time. A sourdough starter is continuously maintained through periodic feedings of flour and water. The periodic feedings introduce challenges for bakers, as, to reach peak fermentation, a sourdough starter is fed in advance of baking. Additionally, growth rates vary among sourdough starters, depending on environmental conditions and feeding schedules.

A common problem faced by bakers is the difficulty of timing and scaling sourdough starter growth to match baking desires. Inconsistent feeding schedules, varying environmental conditions, and unpredictable fermentation rates can make it difficult to grow a sourdough starter that is active and at the desired quantity when desired for baking. Traditional feeding methods rely on manual tracking, requiring users to anticipate and adjust feedings based on experience. If mistimed, the starter may either be underactive when needed for baking or overgrown, requiring discard or maintenance feeding to prevent spoilage.

Accordingly, an improvement in the art is desired to automatically produce a specific amount of sourdough starter. In particular, it may be advantageous in the art to automatically produce a desired amount of sourdough starter, such that a user may more easily maintain a healthy, active starter than through traditional methods.

### BRIEF DESCRIPTION OF THE INVENTION

Aspects and advantages of the invention will be set forth in part in the following description, or may be apparent from the description, or may be learned through practice of the invention.

In one example embodiment, a method of sourdough starter planning in a sourdough making appliance is provided. The sourdough making appliance includes a casing, a user interface positioned on the casing, a container positioned within the casing, a pump fluidly coupled to the container, a water reservoir fluidly coupled to the pump, a hopper positioned above the container, and a dispenser coupled to the hopper. The dispenser is configured to selectively open and close an opening between the hopper and the container. The sourdough making appliance also includes a mixing motor and a mixing attachment mechanically coupled to the mixing motor. The mixing attachment extends within the container. A controller is positioned within the casing. The controller is in operable communication with the pump, the dispenser, and the mixing motor. The method includes receiving, at the user interface, a user input of a desired mass of sourdough starter and a specified end time of a growing operation, and calculating, via a planning algorithm, operating parameters based upon both of the desired mass and the specified end time. The operating parameters include a quantity of starter seed, a dosing schedule, and a dosing quantity. The method also includes performing, by the controller, the growing operation based upon the calculated operating parameters. The growing operation includes feeding a first dosing quantity of flour and a first dosing quantity of water at a first dosing time of the dosing schedule, and monitoring, by the controller, a growth parameter of the sourdough starter within the container. The growth parameter includes a mass of the sourdough starter and a height of the sourdough starter. The growing operation also includes feeding a second dosing quantity of flour and a second dosing quantity of water at a second dosing time of the dosing schedule. The method further includes terminating, via the controller, the growing operation at the desired mass of the sourdough starter and the specified end time.

In another example embodiment, a sourdough making appliance is provided. The sourdough making appliance includes a casing, a user interface positioned on the casing, a container positioned within the casing, a pump fluidly coupled to the container, a water reservoir fluidly coupled to the pump, a hopper positioned above the container, and a dispenser coupled to the hopper. The dispenser is configured to selectively open and close an opening between the hopper and the container. The sourdough making appliance also includes a mixing motor and a mixing attachment mechanically coupled to the mixing motor. The mixing attachment extends within the container. A controller is positioned within the casing. The controller is in operable communication with the pump, the dispenser, and the mixing motor. The controller is configured to receive a user input of a desired mass of sourdough starter and a specified end time of a growing operation, and calculate, via a planning algorithm, operating parameters based upon both of the desired mass and the specified end time. The operating parameters include a quantity of starter seed, a dosing schedule, and a dosing quantity. The controller is also configured to perform the growing operation based upon the calculated operating parameters. The growing operation includes feeding a first dosing quantity of flour and a first dosing quantity of water at a first dosing time of the dosing schedule and monitoring a growth parameter of the sourdough starter within the container. The growth parameter includes a mass of the sourdough starter and a height of the sourdough starter. The growing operation also includes feeding a second dosing quantity of flour and a second dosing quantity of water at a second dosing time of the dosing schedule. The controller is further configured to terminate the growing operation at the desired mass of the sourdough starter and the specified end time.

In another example embodiment, a method of sourdough starter planning is provided. The method includes receiving, at a controller, a user input of a feeding instruction of a growing operation and calculating, via a planning algorithm, operating parameters based upon the feed instruction. The operating parameters include one or more of a quantity of starter seed, a dosing schedule, and a dosing quantity. The method also includes providing, by the controller, a user instruction based upon the calculated operating parameters from the planning algorithm.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a sourdough making appliance according to aspects of the present subject matter.

FIG. 2 provides a side view of a sourdough making appliance according to aspects of the present subject matter.

FIG. 3 provides a schematic, side view of the sourdough making appliance of FIG. 2.

FIG. 4 provides another schematic, side view of the sourdough making appliance of FIG. 2.

FIG. 5 provides a flow chart illustrating an example sourdough making process according to aspects of the present subject matter.

FIG. 6 provides a flow chart illustrating another example sourdough making process according to aspects of the present subject matter.

FIG. 7 provides a flow chart illustrating an example method of sourdough starter planning in a sourdough making appliance, according to aspects of the present subject matter.

FIG. 8 provides a flow chart illustrating an example method of sourdough starter planning, according to aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a ten (10) percent margin, i.e., including values within ten (10) percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

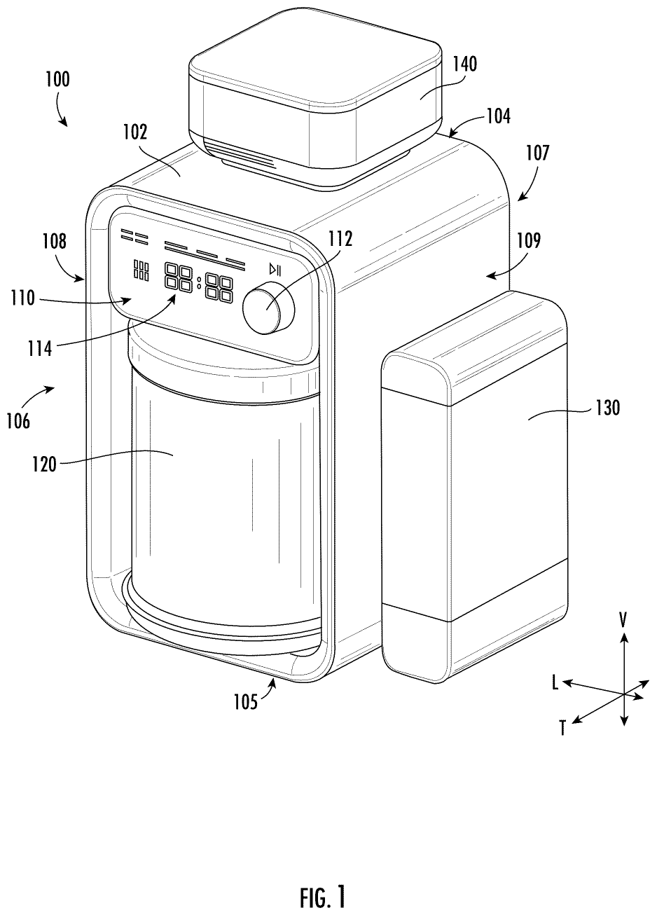

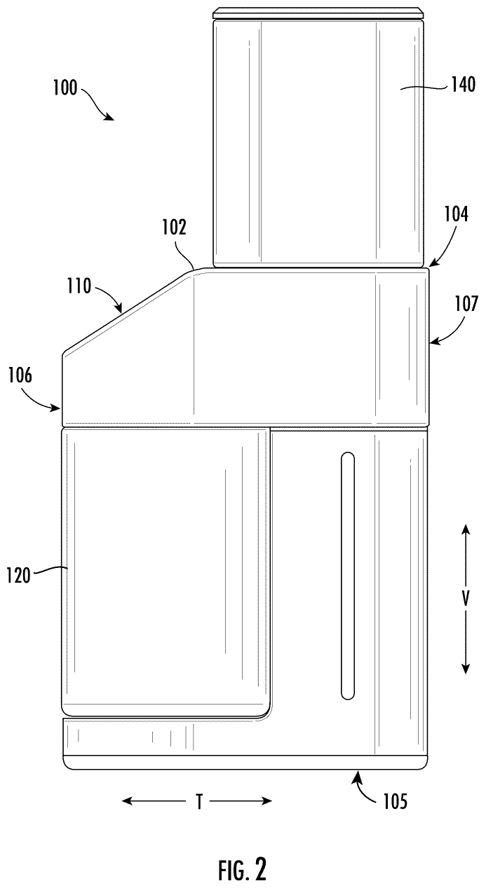

Referring now to the figures, an example appliance will be described in accordance with example aspects of the present subject matter. For example, FIGS. 1 through 4 generally provide example views of a sourdough making appliance 100 according to aspects of the present subject matter. In particular, FIG. 1 provides a perspective view of one example sourdough making appliance 100, and FIG. 2 provides a side view of another example sourdough making appliance 100. Due to the similarity between the sourdough making appliance 100 illustrated in FIG. 1 and sourdough making appliance 100 of FIGS. 2 through 4, like reference numerals may be used to refer to the same or similar features. As illustrated, sourdough making appliance 100 generally defines a vertical direction V, a lateral direction L, and a transverse direction T, each of which is mutually perpendicular, such that an orthogonal coordinate system is generally defined.

According to example embodiments, sourdough making appliance 100 includes a casing 102 that is generally configured for containing and/or supporting various components of sourdough making appliance 100 and which may also define one or more internal chambers or compartments of sourdough making appliance 100. In this regard, as used herein, the terms “casing,” “cabinet,” “housing,” and the like are generally intended to refer to an outer frame or support structure for sourdough making appliance 100, e.g., including any suitable number, type, and configuration of support structures formed from any suitable materials, such as a system of elongated support members, a plurality of interconnected panels, or some combination thereof. It should be appreciated that casing 102 does not necessarily require an enclosure and may simply include open structure supporting various elements of sourdough making appliance 100. By contrast, casing 102 may enclose some or all portions of an interior of casing 102. It should be appreciated that casing 102 may have any suitable size, shape, and configuration while remaining within the scope of the present subject matter.

As illustrated, casing 102 generally extends between a top side 104 and a bottom side 105 along the vertical direction V, between a front side 106 and a rear side 107 along the transverse direction T, and between a first side 108 (e.g., the left side when viewed from the front as in FIG. 1) and a second side 109 (e.g., the right side when viewed from the front as in FIG. 1) along the lateral direction L. In general, terms such as “left,” “right,” “front,” “rear,” “top,” or “bottom” are used with reference to the perspective of a user accessing sourdough making appliance 100.

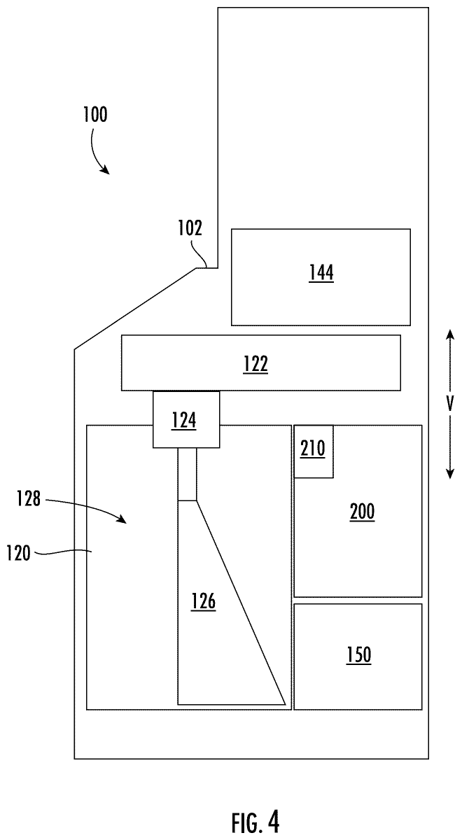

As may be seen in FIGS. 1 and 2, a container 120 may be positioned within casing 102. In general, container 120 may be a hollow, cylindrical crock or jar defining an interior 128 (FIG. 4) of container 120 configured to contain a sourdough starter and ingredients thereof. As seen in FIG. 4, sourdough making appliance 100 may include a mixing motor 122 mechanically coupled to a mixing attachment 126, such as via a coupling 124. In general, mixing attachment 126 may extend within container 120, such as within interior 128 of container 120 in order to mix sourdough starter within container 120. One of skill in the art would understand that mixing attachment 126 may generally be any suitable type of mixing attachment, such as a dough hook, a beater, a whisk, etc.

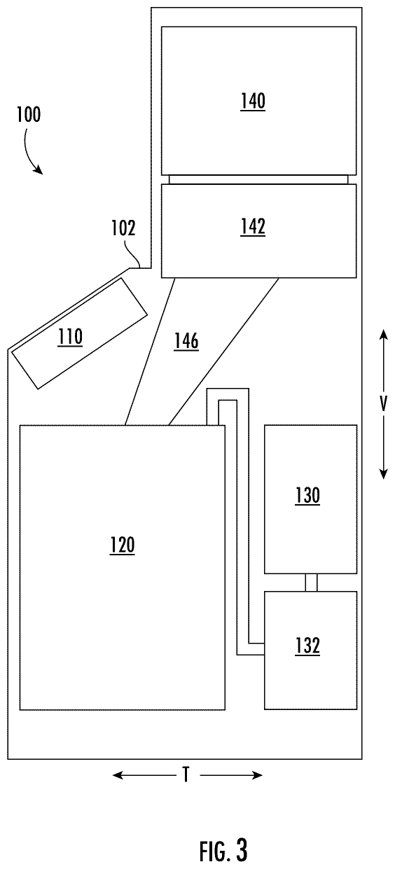

As may be seen in FIGS. 1 and 3, sourdough making appliance 100 includes a reservoir 130, e.g., a water reservoir. In the example embodiment shown in FIG. 1, reservoir 130 may be external to casing 102 and fluidly coupled to sourdough making appliance 100. In the example embodiment shown in FIG. 3, reservoir 130 may be positioned within casing 102, thereby fluidly coupled within sourdough making appliance 100. In general, reservoir 130 may be selectively removable, or detachable, from sourdough making appliance 100, such that a user may remove reservoir 130 to add/remove water. In general, water reservoir 130 may be fluidly coupled to a pump 132. In particular, pump 132 may be positioned within casing 102 and may be fluidly coupled to container 120, such that pump 132 may be configured to pump water from reservoir 130 into container 120.

As may be seen in FIGS. 1 through 3, a hopper 140 may be positioned above container 120, such as in the vertical direction V. Hopper 140 may generally be a square, rectangular, and/or funnel-shaped receptacle for grains, such as flour, for feeding the sourdough starter. In particular, a dispenser 142 may be operably coupled to hopper 140. Dispenser 142 may generally be mechanically coupled to a dispenser motor 144 (FIG. 4), whereby dispenser 142 selectively opens and closes an opening 146 between hopper 140 and container 120. In some example embodiments, dispenser 142 may include an auger (not shown) generally configured to convey flour from hopper 140 to container 120 through opening 146.

As may be seen in FIG. 4, sourdough making appliance 100 may include a user interface 110 positioned at/on casing 102 that may represent a general-purpose Input/Output (“GPIO”) device or functional block for appliance 100. In some embodiments, user interface 110 may include or be in operative communication with one or more user input devices 112, such as one or more of a variety of digital, analog, electrical, mechanical, or electro-mechanical input devices including rotary dials, control knobs, push buttons, toggle switches, selector switches, and touch pads. Additionally, sourdough making appliance 100 may include a display 114, such as a digital or analog display device generally configured to provide visual feedback regarding the operation of sourdough making appliance 100. For example, display 114 may be provided on user interface 110 and may include one or more status lights, screens, or visible indicators. According to example embodiments, user input devices 112 and display 114 may be integrated into a single device, e.g., including one or more of a touchscreen interface, a capacitive touch panel, a liquid crystal display (LCD), a plasma display panel (PDP), or other informational or interactive displays.

Sourdough making appliance 100 may further include or be in operative communication with a processing device or a controller 200 that may be generally configured to facilitate appliance operation. In this regard, user interface 110, user input devices 112, and display 114 may be in communication with controller 200 such that controller 200 may receive control inputs from user input devices 112, may display information using display 114, and may otherwise regulate operation of sourdough making appliance 100. For example, signals generated by controller 200 may operate sourdough making appliance 100, including any or all system components, subsystems, or interconnected devices, in response to the position of user input devices 112 and other control commands, e.g., controller 200 may be in operable communication with pump 132, dispenser 142, and mixing motor 122. User interface 110 and other components of sourdough making appliance 100 may be in communication with controller 200 via, for example, one or more signal lines or shared communication busses. In this manner, Input/Output (“I/O”) signals may be routed between controller 200 and various operational components of sourdough making appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 200 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 200 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 200 may be operable to execute programming instructions or micro-control code associated with an operating cycle of sourdough making appliance 100. In this regard, the instructions may be software or any set of instructions that when executed by the processing device, cause the processing device to perform operations, such as running one or more software applications, displaying user interface 110, receiving user input, processing user input, etc. Moreover, it should be noted that controller 200 as disclosed herein is capable of and may be operable to perform any methods, method steps, or portions of methods as disclosed herein. For example, in some embodiments, methods disclosed herein may be embodied in programming instructions stored in the memory and executed by controller 200.

The memory devices may also store data that can be retrieved, manipulated, created, or stored by the one or more processors or portions of controller 200. The data can include, for instance, data to facilitate performance of methods described herein. The data can be stored locally (e.g., on controller 200) in one or more databases and/or may be split up so that the data is stored in multiple locations. In addition, or alternatively, the one or more database(s) can be connected to controller 200 through any suitable network(s), such as through a high bandwidth local area network (LAN) or wide area network (WAN). In this regard, for example, controller 200 may further include a communication module or interface that may be used to communicate with one or more other component(s) of sourdough making appliance 100, controller 200, an external appliance controller, or any other suitable device, e.g., via any suitable communication lines or network(s) and using any suitable communication protocol. The communication interface may include any suitable components for interfacing with one or more network(s), including for example, transmitters, receivers, ports, controllers, antennas, or other suitable components.

Furthermore, as may be seen in FIG. 4, sourdough making appliance 100 may include a power supply 150. For example, sourdough making appliance 100 may include a twelve volt direct current (12 VDC) power supply positioned within casing 102. In other example embodiments, sourdough making appliance 100 may be electrically coupled to an external power supply, such as a municipal power grid or any other suitable supply of power. One of skill in the art would understand the twelve volt direct current (12 VDC) power supply is provided by way of example only and power supply 150 may be any suitable direct current voltage or power source.

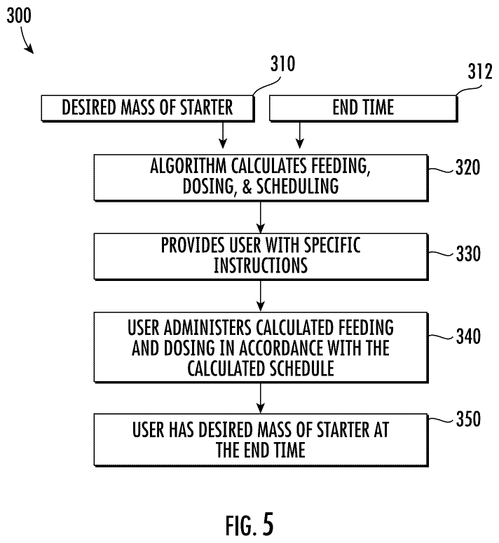

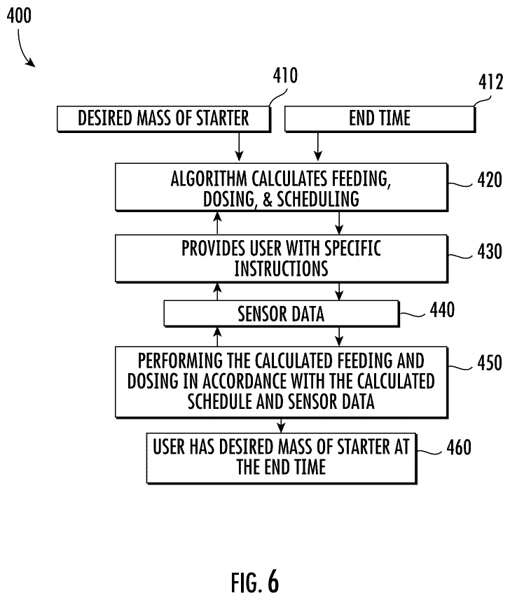

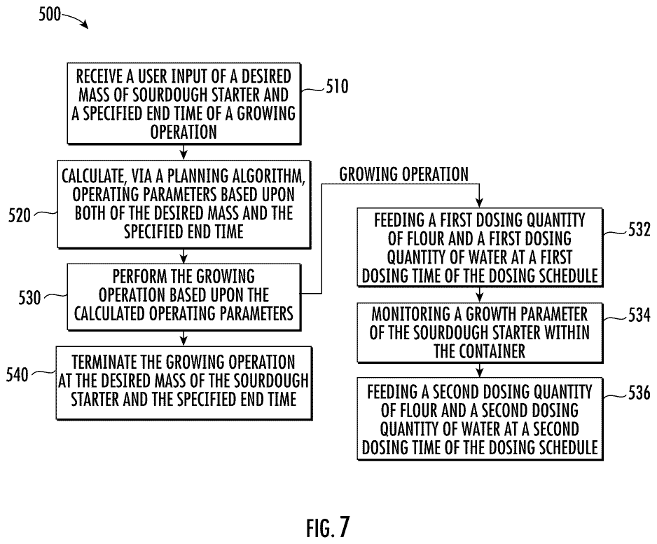

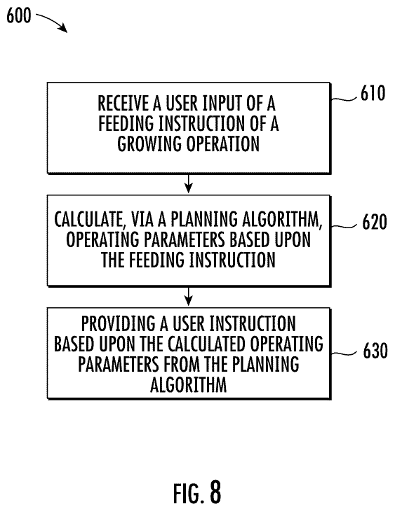

Now that the construction of sourdough making appliance 100 and the configuration of controller 200 according to example embodiments have been presented, example sourdough making process 300 (FIG. 5) and 400 (FIG. 6), an example method 500 (FIG. 7) and an example method 600 (FIG. 8) of planning a sourdough starter will be described. Although the discussion below refers to the example processes 300, 400 and methods 500, 600 of sourdough starter planning with sourdough making appliance 100, one skilled in the art will appreciate that the example processes 300, 400 and methods 500, 600 are applicable to the operation of a variety of other appliances, or, as in method 600, may be performed without a dedicated appliance. In some example embodiments, the various process and method steps as disclosed herein may be performed by controller 200 or a separate, dedicated controller.

Referring to FIGS. 5 through 8, depicted are operations performed in a particular order for purposes of illustration and discussion. Those of ordinary skill in the art, using the disclosures provided herein, will understand that any of the methods discussed herein can be adapted, rearranged, expanded, omitted, or modified in various ways without deviating from the scope of the present disclosure. Moreover, although aspects of processes 300, 400 as well as methods 500, 600 are explained using sourdough making appliance 100 as an example, it should be appreciated that these methods may be applied to the operation of any suitable sourdough making appliance.

FIGS. 5 and 6 illustrate example sourdough making process according to aspects of the present subject matter. In general, FIG. 5 illustrates one example process 300, where a user inputs information into an algorithm and then follows instructions provided by the algorithm in order to reach a desired mass of sourdough starter. FIG. 6 generally illustrates one example process 400, where a user inputs information into an algorithm and then a sourdough making appliance automatically performs the provided instructions from the algorithm, as well as monitors data from various sensors indicative of the growth of the sourdough starter, in order to reach a desired mass of sourdough starter.

In particular, looking specifically at FIG. 5, a user may be prompted to provide information that will be used to calculate a feeding strategy and a schedule. The information the user may provide includes an amount of mature sourdough starter available to the user, e.g., a mass or a volume, a type of flour, a desired mass of sourdough starter (e.g., at 310), and/or an end desired date and time user intends to utilize the sourdough starter (e.g., at 312).

Based on these inputs, an algorithm (e.g., 320) will calculate various parameters, such as the amount of mature starter that the user should place into the container as the initial inoculum. In addition, the algorithm will also calculate an appropriate feeding strategy that includes a number of feedings, e.g., between the present time and the user's desired end time, a feeding ratio or dosage, e.g., the amount of water and flour to be added at each feeding, and a mixing time, e.g., to promote proper homogenization. For example, using the information provided by the user, e.g., the mass of mature sourdough starter, the type of flour, the desired mass, and/or the end desired date and time, the algorithm may evaluate and produce the feeding strategy by calculating a number of feedings within a length of time, e.g., defined by the start time and the desired end time, comparing the length of time to an expected peak time (e.g., comparing the expected time the sourdough will be ready to the desired end time), and determining the feeding ratio or dosage per interval to achieve the expected peak time at the desired end time.

The timing of each feeding and corresponding dosages is calculated to provide a prediction of growth, a tailored feeding schedule, and approximate timing. By controlling the timing and dosage of each feeding, the growth of the starter may be predicted to ensure that the desired mass of sourdough starter is achieved at approximately the specified end time. Thus, shortages or surplus of starter may be reduced, thereby providing the user with the desired amount. The designated feeding schedule ensures the microbiota population is effectively propagated and remains vital throughout all feedings. The schedule is calculated to reduce or prevent risk of overspill due to excessive fermentation growth, while maintaining the health of the microbial community. Thus, the user may bypass discarding excess starter during the course of propagation. Furthermore, with the provided end time at which the user desires the matured sourdough starter, the timing of a final feeding may be calculated so that a peak growth of the starter aligns approximately with the user's desired end time.

At (330), the user may be provided with the specific calculated instructions, e.g., including the feeding strategy. In general, the instructions may be provided to the user via any suitable communications, such as a text to a smartphone, a notification in an application, or on a display in direct communication with the controller, etc., as will be described in further detail below. Thus, at (340), the user may administer the calculated feeding and dosing in accordance with the calculated schedule. In other words, process 300 includes a user manually performing the specific calculated instructions. As such, at (350) the user may receive the desired mass of sourdough starter at the desired end time.

Looking now specifically at FIG. 6, process 400 includes a user providing information that will be used to calculate a feeding strategy and a schedule, e.g., (410) and (412) of process 400 are the same or similar to (310) and (312) of process 300. Additionally, (420) and (430) of process 400 may, respectively, include an algorithm calculating various parameters based on the provided inputs and providing the user with the specific calculated instructions, e.g., as described the same or similar to (320) and (330) of process 300.

Process 400 differs from process 300 from 440 onwards, where, at (440), the algorithm receives sensor data, such as from a sourdough making appliance. In general, a sensor, or multiple sensors, such as a plurality of sensors, may be provided within sourdough making appliance 100 to monitor the growth of the sourdough starter after each feeding. The sensor data may be compared to an expected growth rate, e.g., compared to the actual growth rate, and adjustments to the feed strategy may be calculated by the algorithm. In addition, the sensor(s) may detect deviations from expected growth and notification(s) of such deviations may be communicated to a user.

Process 400 continues at (450), where a sourdough making appliance may automatically perform the calculated feeding and dosing in accordance with the calculated schedule and sensor data from (440), as will be explained further below. As such, at (460) the user may receive the desired mass of sourdough starter at the desired end time.

As may be seen in FIG. 7, at 510, method 500 may generally include receiving a user input of a desired mass of sourdough starter and a specified end time of a growing operation. For example, user interface 110 of sourdough making appliance 100 receives a desired mass of sourdough starter (e.g., in ounces, pounds, and/or kilograms) and a specified end time of the growing operation (e.g., a desired date and time). In some embodiments, a user may additionally input an initial quantity of sourdough starter, such as a mass of sourdough starter a user already has grown. In yet further embodiments, a user may additionally input a type of flour for the sourdough starter, e.g., a type of flour provided in hopper 140 of sourdough making appliance 100. For example, various types of flours may include, but are not limited to, wheat flour, buckwheat flour, almond flour, rice flour, all-purpose flour, etc. In particular, sourdough making appliance 100 may provided a selection menu on display 114 of user interface 110, where a user may select the flour type from a predetermined list of flours.

At 520, method 500 may generally include calculating, via a planning algorithm, operating parameters based upon both of the desired mass and the specified end time. The planning algorithm may generally be an algorithm stored in the memory portions of controller 200, as described above. In general, the operating parameters include a quantity of starter seed, a dosing schedule, and a dosing quantity. In particular, the quantity of starter seed calculated by the planning algorithm is an amount of start seed to grow the sourdough starter to the desired mass, the dosing schedule is the frequency and/or number of feedings in order to grow the sourdough starter to the desired mass by the specified end time, and the dosing quantity is how much of flour and/or water to feed the sourdough starter at each feeding. In general, the dosing quantity of flour may be grams of flour, and the dosing quantity of water may be ounces of water. For example, as stated above, using the desired mass and the specified end time the algorithm may calculate a number of feedings within a total length of time, e.g., defined by the start time (e.g., the current time of calculation) and the desired end time. The algorithm may then compare the length of time to an expected peak time, e.g., comparing when the sourdough will be ready to the desired end time, whereby the algorithm may determine the feeding ratio or dosage per interval (per feeding time) to achieve the expected peak time at the desired end time.

Method 500 may further include providing a user instruction, such as a recipe or growth strategy, e.g., an instruction which includes each of the quantity of starter seed, the dosing schedule, and the dosing quantities, based upon the calculated operating parameters at 520. This instruction may be presented to the user via any suitable communications, such as a text to a smartphone, a notification in an application, e.g., a mobile application, or, for example, on display 114 of user interface 110 in communication with the planning algorithm through controller 200.

At 530, method 500 may generally include performing the growing operation based upon the calculated operating parameters. For example, at 532, the growing operation may generally include feeding a first dosing quantity of flour and a first dosing quantity of water at a first dosing time of the dosing schedule. The feeding of the sourdough starter during the growing operation may also include mixing the sourdough starter within container 120. For example, as described above, mixing motor 122 may be mechanically coupled to mixing attachment 126, such that mixing attachment 126 may extend within container 120, e.g., within interior 128 of container 120, in order to mix sourdough starter within container 120. In particular, mixing the sourdough starter within container 120 may include mixing the sourdough starter for a calculated period of time, e.g., the period of time calculated by the planning algorithm at 520. In general, the period of time for mixing may be between one second (1 s) and six hundred seconds (600 s), such as between ten seconds (10 s) and three hundred (300 s), such as between thirty seconds (30 s) and one hundred and fifty seconds (150 s).

At 534, the growing operation may generally include monitoring a growth parameter of the sourdough starter within the container. For example, the growth parameter may include a mass of the sourdough starter and/or a height of the sourdough starter. In particular, sourdough making appliance 100 may include a sensor 210, or multiple sensors, in data communication with controller 200. Sensor 210 may be any suitable sensor or plurality of sensors for detecting/monitoring height, weight, and/or temperature. In combination with sensor 210, the growing operation may include receiving the growth parameter of the sourdough starter, calculating, via the planning algorithm, updated operating parameters based upon the received growth parameter, and performing the growing operation based upon the updated operating parameters. For example, sensor 210 may detect the sourdough starter growing taller, or faster, than expected by the algorithm, in response to which the planning algorithm may adjust the operating parameters, such as reducing the dosing quantities (e.g., of water and flour) to slow the growth rate of the sourdough, based upon the received height (growth parameter). In an opposite example, it may be detected that the sourdough starter growing slower than expected by the algorithm, in response to which the planning algorithm may adjust the operating parameters, such as increasing the dosing quantities (e.g., of water and flour) to increase the growth rate of the sourdough, again based upon the received height (growth parameter). Additionally, method 500 may further include providing the user instruction based upon the updated operating parameters.

Accordingly, at 536, the growing operation may generally include feeding a second dosing quantity of flour and a second dosing quantity of water at a second dosing time of the dosing schedule. In general, feeding the second dosing quantities of flour and water at the second dosing time may include the original operating parameters, or may include the updated operating parameters, depending upon the growth parameter. For example, when the monitored growth parameter is as expected by the algorithm, the originally calculated operating parameters may be used.

At 540, method 500 may generally include terminating the growing operation at the desired mass of the sourdough starter and the specified end time. In particular, sourdough making appliance 100 may end the growing operation at the specified end time, e.g., when the sourdough starter is approximately at the desired mass.

Turning now to FIG. 8, as stated above, example method 600 may be performed without a dedicated appliance, e.g., instead a separate dedicated controller may perform various method steps as disclosed herein. In some example embodiments, various processes and functions of method 600 may be performed remotely, over a webpage, application, on a smartphone, or otherwise via the internet.

At 610, method 600 may generally include receiving at a controller a feeding instruction of a growing operation. In general, the feeding instruction may include a dosing quantity of flour and a dosing quantity of water, e.g., specified by the user at the start of the growing operation. Method 600 may also include receiving a user input of an initial quantity of sourdough starter. At 620, method 600 may generally include calculating, via a planning algorithm, operating parameters based upon the feeding instruction. As stated above, the operating parameters may include one or more of a quantity of starter seed, a dosing schedule, and a dosing quantity. Additionally or alternately, the dosing schedule may be initially received with the feeding instruction. At 630, method 600 may generally include providing a user instruction based upon the calculated operating parameters from the planning algorithm. For example, the feeding instruction may define the dosing quantity, e.g., the dosing quantity of flour and the dosing quantity of water, and the dosing schedule, which may include a specified series of times to administer the dosing quantity to grow the mass of sourdough starter. Accordingly, method 600 specifically improves the sourdough making process in order to make sourdough starter as desired by a user.

The above described methods 500, 600 may advantageously provide an improved sourdough making process, whereby the desired mass of sourdough starter is produced at the desired end time. Additionally, the sourdough starter may be grown to the desired mass with the calculated feeding quantities and may be produced without excess sourdough starter, therefore advantageously reducing ingredient waste or discarding.

As may be seen from the above, a sourdough making appliance and a growth planning algorithm for a sourdough starter growing operation are provided. When a user inputs a desired mass of sourdough starter and a time/date they desire to have the sourdough starter by, the planning algorithm may calculate and provide a schedule and specific plan for the sourdough starter growing operation to the user. The algorithm may provide a quantity of seed starter required, a dosing schedule, and dosing quantity. When the sourdough appliance is operated according to these outputs from the algorithm, e.g., when the sourdough starter is fed according to the dosing schedule to maintain growing performance, the desired mass of sourdough (e.g., without excess that may be spilled during the process or discarded after the process) may be provided at the specified time and date.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of sourdough starter planning in a sourdough making appliance, the sourdough making appliance comprising a casing, a user interface positioned on the casing, a container positioned within the casing, a pump fluidly coupled to the container, a water reservoir fluidly coupled to the pump, a hopper positioned at the casing, a dispenser coupled to the hopper, a mixing motor and a mixing attachment mechanically coupled to the mixing motor, the mixing attachment extending within the container, and a controller positioned within the casing, the controller in operable communication with the pump, the dispenser, and the mixing motor, the method comprising:
receiving, at the user interface, a user input of a desired mass of sourdough starter and a specified end time of a growing operation;
calculating, by the controller according to a planning algorithm, operating parameters based upon both of the desired mass and the specified end time, the operating parameters comprising a quantity of starter seed, a dosing schedule, and a dosing quantity;
performing, by the controller, the growing operation based upon the calculated operating parameters, the growing operation comprising;
feeding a first dosing quantity of flour and a first dosing quantity of water at a first dosing time of the dosing schedule;
monitoring, by the controller, a growth parameter of the sourdough starter within the container, the growth parameter comprising a mass of the sourdough starter;
feeding a second dosing quantity of flour and a second dosing quantity of water at a second dosing time of the dosing schedule; and
terminating, via the controller, the growing operation at the desired mass of the sourdough starter and the specified end time.

2. The method of claim 1, further comprising: providing, by the controller, a user instruction based upon the calculated operating parameters.

3. The method of claim 1, further comprising:
receiving, at the controller, the growth parameter of the sourdough starter;
calculating, by the controller according to the planning algorithm, updated operating parameters based upon the received growth parameter; and
performing, by the controller, the growing operation based upon the updated operating parameters.

4. The method of claim 3, further comprising: providing, by the controller, a user instruction based upon the updated operating parameters.

5. The method of claim 1, wherein feeding the sourdough starter during the growing operation comprises mixing, by the controller, the sourdough starter within the container.

6. The method of claim 5, wherein mixing the sourdough starter within the container comprises mixing for a calculated period of time.

7. The method of claim 1, wherein receiving a user input of a desired mass of sourdough starter and a specified end time of the growing operation further comprises receiving an initial quantity of sourdough starter.

8. The method of claim 1, wherein receiving a user input of a desired mass of sourdough starter and a specified end time of the growing operation further comprises receiving a type of flour for the sourdough starter.

9. A sourdough making appliance, comprising:
a casing;
a user interface positioned on the casing;
a container positioned within the casing;
a pump fluidly coupled to the container;
a water reservoir fluidly coupled to the pump;
a hopper positioned at the casing;
a dispenser coupled to the hopper;
a mixing motor and a mixing attachment mechanically coupled to the mixing motor, the mixing attachment extending within the container; and
a controller positioned within the casing, the controller in operable communication with the pump, the dispenser, and the mixing motor, the controller configured to:
receive a user input of a desired mass of sourdough starter and a specified end time of a growing operation;
calculate, via a planning algorithm, operating parameters based upon both of the desired mass and the specified end time, the operating parameters comprising a quantity of starter seed, a dosing schedule, and a dosing quantity;
perform the growing operation based upon the calculated operating parameters, the growing operation comprising;
feeding a first dosing quantity of flour and a first dosing quantity of water at a first dosing time of the dosing schedule;
monitoring, by the controller, a growth parameter of the sourdough starter within the container, the growth parameter comprising a mass of the sourdough starter;
feeding a second dosing quantity of flour and a second dosing quantity of water at a second dosing time of the dosing schedule; and
terminate, via the controller, the growing operation at the desired mass of the sourdough starter and the specified end time.

10. The sourdough making appliance of claim 9, wherein the controller is configured to provide a user instruction based upon the calculated operating parameters.

11. The sourdough making appliance of claim 9, wherein the controller is further configured to:
receive the growth parameter of the sourdough starter;
calculate, via the planning algorithm, updated operating parameters based upon the received growth parameter; and
perform the growing operation based upon the updated operating parameters.

12. The sourdough making appliance of claim 11, wherein the controller is further configured to provide a user instruction based upon the updated operating parameters.

13. The sourdough making appliance of claim 9, wherein feeding the sourdough starter during the growing operation comprises the controller configured to mix the sourdough starter within the container.

14. The sourdough making appliance of claim 13, wherein mixing the sourdough starter within the container comprises mixing for a calculated period of time.

15. The sourdough making appliance of claim 9, wherein receiving a user input of a desired mass of sourdough starter and a specified end time of the growing operation comprises the controller further configured to receive an initial quantity of sourdough starter.

16. The sourdough making appliance of claim 9, wherein receiving a user input of a desired mass of sourdough starter and a specified end time of the growing operation comprises the controller further configured to receive a type of flour for the sourdough starter.

17. A method of sourdough starter planning, the method comprising:
receiving, at a controller, a feeding instruction of a growing operation;
calculating, via a planning algorithm, operating parameters based upon the feeding instruction, the operating parameters comprising one or more of a quantity of starter seed, a dosing schedule, and a dosing quantity;
providing, by the controller, a user instruction based upon the calculated operating parameters from the planning algorithm.

18. The method of claim 17, wherein the feeding instruction comprises a dosing quantity of flour and a dosing quantity of water.

19. The method of claim 18, wherein the dosing schedule comprises a specified series of times to administer the dosing quantity to grow the desired mass of sourdough starter.

20. The method of claim 17, wherein receiving the feeding instruction of the growing operation further comprises receiving an initial quantity of sourdough starter.
